(19) United States
(12) Patent Application Publication
(10) Pub. No.: US 2007/0246098 A1
(43) Pub. Date: Oct. 25, 2007

(54) Decorative Motion Lamp

(76) Inventors: Gregory E. Burke JR., Carol Stream, IL (US); Brian Mila, Downers Grove, IL (US)

Correspondence Address: WELSH & KATZ, LTD, 120 S RIVERSIDE PLAZA, 22ND FLOOR, CHICAGO, IL, 60606, US

(21) Appl. No.: 11/689,275

(22) Filed: Mar. 21, 2007

Related U.S. Application Data
(60) Provisional application No. 60/784,913, filed on Mar. 22, 2006.

(51) Int. Cl. F27D 21/02; F17D 3/01

(52) U.S. Cl. 137/9; 362/126

(57) ABSTRACT

A lamp for creating a decorative visual effect from the movement of fluids contained therein. In one form, the lamp features a tank having opposing front and rear surfaces that are substantially parallel to one another, at least one light source, a plurality of immiscible fluids of varying densities contained within the tank and a housing unit for aesthetically and functionally supporting the tank. The light source illuminates the liquids within the tank and can provide sufficient radiant heat to cause the temperature of the fluids within the tank to increase such that they become less dense. As the fluids within the tank become warmer and less dense, they begin to rise in the tank at varying rates and can create a dynamic visual display. In addition to the light source, alternative heat sources can be employed to provide added heat to the immiscible fluids within the tank.

### CROSS REFERENCE TO RELATED APPLICATION

This application claims priority from U.S. Provisional Patent Application Ser. No. 60/784,913 filed Mar. 22, 2006 entitled “Decorative Motion Lamp.”

### FIELD OF THE INVENTION

The present invention relates generally to a lamp for creating a decorative visual display, and is particularly directed to a lamp having at least one light source, at least one heat source and a tank containing a plurality of immiscible fluids that are illuminated by a light source and heated by a heat source in a manner in which they become agitated within the tank.

### BACKGROUND OF THE INVENTION

Liquid motion lamps, as they are sometimes commonly referred to, are primarily decorative novelty devices that have been generally well known since the 1960s. These lamps are typically relatively simple devices that produce a visual display caused by the movement of fluid within a glass bottle. The most common types of liquid motion lamps generally consist of a lamp having a single illuminating bulb, a glass bottle containing a transparent oil and translucent wax, and a metallic wire coil. The glass bottle sits on top of the bulb, which heats its contents. The metallic wire coil is hidden in the base of the lamp on which the glass bottle is sitting.

The wax in these devices is generally slightly denser than the oil at room temperature, and slightly less dense than the oil under marginally warmer conditions. When the lamp is turned on, the light bulb heats the bottom of the glass bottle which in turn heats the contents in its vicinity. The wax at the bottom of the bottle heats until it melts, and eventually becomes less dense than the liquid above it. At this time, a portion of the wax rises towards the top of the container. Near the top, away from the heat source, the wax cools, contracts, and as its density increases it begins to fall through the liquid towards the bottom of the container again. The rising and falling of the wax within the bottle thus produces a dynamic visual display that can be mesmerizing for an observer.

Known types of liquid motion lamps generally use a single light source to illuminate the contents within the bottle and a single heat source to heat the contents in order to cause them to move within the bottle. For this reason, many types of motion lamps are relatively small devices that provide minimal illumination and visual effect. Using a larger type of bottle or container in connection with these types of motion lamps would be impractical because the single heat source would be insufficient to heat the contents of the bottle to a sufficient temperature to enable the wax within the container to rise to a significant level.

Often times various entertainment venues such as bars, dance clubs or concert halls prefer to employ visual displays in various locations around their establishments for decorative purposes and in order to give patrons an enhanced visual experience. Such displays can stimulate the patron's visual senses and contribute to a more enjoyable entertainment experience. Liquid motion lamps are an example of one kind of display that can have such an effect. Generally, larger visual displays have more of an effect on persons present at a particular venue than those of smaller sizes. There is thus a need for a larger type of motion lamp having an aesthetically pleasing appearance. It would be further desirable if such a lamp could be mounted to or recessed within a wall, ceiling, door or other building structure or room partition, or be made to stand alone in a manner in which it would be supported and not otherwise tip.

### SUMMARY OF THE INVENTION

One embodiment of the present invention is directed to a decorative motion lamp featuring a tank having a plurality of surfaces including opposing front and rear surfaces substantially parallel to one another, a housing unit adapted to support the tank, a plurality of immiscible fluids contained in the tank, at least one heat source suitable for heating the fluids within the tank and at least one light source suitable for illuminating the fluids contained in the tank. In one embodiment of the invention, the light source can also act as a heat source, or if more heat is required, supplemental heat sources can be used to provide additional heat to the fluids within the tank.

The tank for the motion lamp can be constructed from any material designed to withstand the temperature of the associated heat source(s) without becoming damaged and is preferably constructed from materials such as, for example, tempered glass, silica glass, fiberglass, laminated glass or clear plastic so that at least the front surface of the tank is transparent so that the fluids within the tank can be seen from the outside the tank.

The housing unit of the tank can be made from a variety of materials such as metal, wood, or fiberglass and is of sufficient size and strength to hold the tank filled with liquid as well as the associated lighting and heating sources. The housing can be constructed so that the tank can either stand alone on a table or platform or can be constructed so that the tank can be mounted to a wall similar to a painting or a flat screen television. The housing can also be constructed such that the lamp can be recessed into a wall or glazed into a building's windows, aluminum storefront, curtain wall, wall partitions, or doors.

In one form of the invention, the fluids within the tank can be made from any material provided the two materials are in liquid form at operating temperature and immiscible with each other. In one embodiment, the fluids should be of very similar, but not identical, densities when at room temperature or when heated to a particular temperature within the tank. In addition, at least one fluid within the tank should have a property characteristic such that it changes densities when heated above room temperature. This property is present in any fluid which expands as it gets hotter so that when it is warmed it will become less dense and begin to rise in the tank, thus forming decorative patterns. After the denser fluids rise to the top of the tank they will gradually cool because they are no longer close to the heat source. After the denser liquids have cooled to a sufficient degree they will begin to sink back down to the bottom of the tank. When the cooler liquid reaches the bottom of the tank it will once again be heated by the heat source(s), perpetuating the cycle.

In addition to the light source, alternative heat sources may be used to heat the fluid within the tank. These alternative heat sources could be, for example, electrical heating elements such as heat strips, heating rods, cartridge heaters, disk/ring heaters, as well as infrared heaters or microwaves. The alternative heat sources can be mounted either inside or outside the tank and may be either fixed temperature heat sources or may be electrically monitored and controlled via a thermocouple and temperature controlling device or digital electrical circuitry to maintain the proper operating temperature of fluid within the tank. In yet other embodiments, the heat sources may also be set to fluctuate to create dynamic patterns in the liquids. This fluctuation can be created by either setting multiple heat sources to differing temperatures using dimmer switches or dials or may be controlled dynamically using a computer, microprocessor, or other controlling circuitry.

The light sources for the lamp are used to illuminate, and sometimes heat, the liquids within the tank to create a dynamic light show. The light sources can be mounted anywhere close to the tank, including below the tank, behind the tank, in front of the tank or on the side of the tank. The light source(s) need not be contained within the housing of the tank. In one embodiment, the light sources may provide enough radiant heat to also be used as the exclusive heat source for the lamp.

A method of producing a dynamic visual display is further provided by the present invention. The method features heating a plurality of immiscible fluids contained within a tank by a plurality of heat sources such that at least one fluid changes density and rises within the tank, illuminating the tank with a light source, and fluctuating the heat sources to vary the movement of the fluid within the tank.

### BRIEF DESCRIPTION OF THE DRAWINGS

FIG. 1 is a front elevation view of one embodiment of the decorative motion lamp of the present invention.

FIG. 2 is a side elevation view of the decorative motion lamp shown in FIG. 1.

FIG. 3 is a side elevation view in cross section of another embodiment of the decorative motion lamp having an internal supplemental heat source.

FIG. 4 is a side elevation view in cross section of another embodiment of the decorative motion lamp having an external supplemental heat source.

FIG. 5 is a perspective view of one embodiment of the decorative motion lamp of the present invention in operation.

FIG. 6 is a perspective view of another embodiment of the decorative motion lamp of the present invention having heater plates.

FIG. 7 is a side view in partial cross section of the base of the lamp shown in FIG. 6.

FIG. 8a is a perspective view of another embodiment of the decorative motion lamp of the present invention having infrared heaters.

FIG. 8b is a front elevation view of the decorative motion lamp shown in FIG. 8a.

FIG. 9 is a perspective view of a decorative motion lamp having a tank with an angled top surface according to another embodiment of the present invention.

FIG. 10a is a perspective view of a decorative motion lamp having a tank with an angled top and bottom surface according to another embodiment of the present invention.

FIG. 10b is a front elevation view of the decorative motion lamp shown in FIG. 10a.

FIG. 10c is a side elevation view of the decorative motion lamp shown in FIG. 10a.

FIG. 11a is a front elevation view of another embodiment of the decorative motion lamp featuring a clamp apparatus operatively associated with the tank.

FIG. 11b is a side elevation view of the decorative motion lamp shown in FIG. 11a.

FIG. 12 is a perspective view of another embodiment of the decorative motion lamp the present invention having an external heating and cooling unit.

FIG. 13a is a perspective view of another embodiment of the decorative motion lamp having an outer shell.

FIG. 13b is a side elevation view of the decorative motion lamp shown in FIG. 13a.

FIG. 14 is a front view of another embodiment of the lamp having a tank with moveable rotating objects.

FIG. 15 is a front view of another embodiment of the lamp having a stationary objects contained in the tank.

### DETAILED DESCRIPTION

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

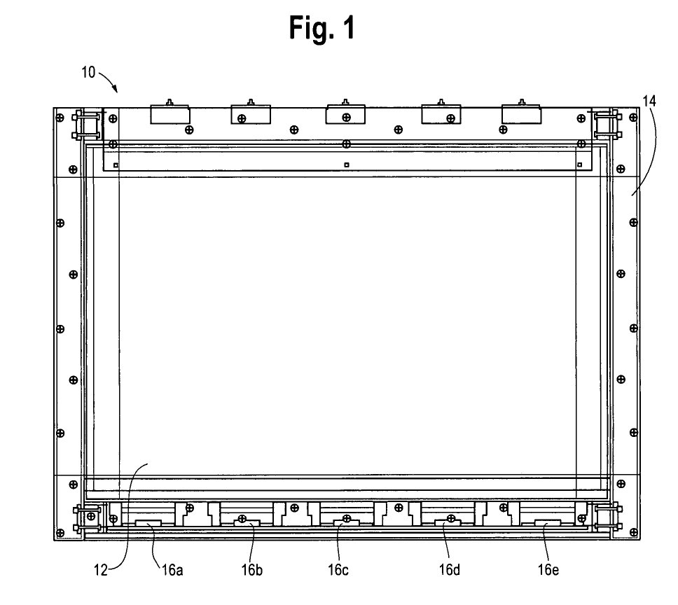

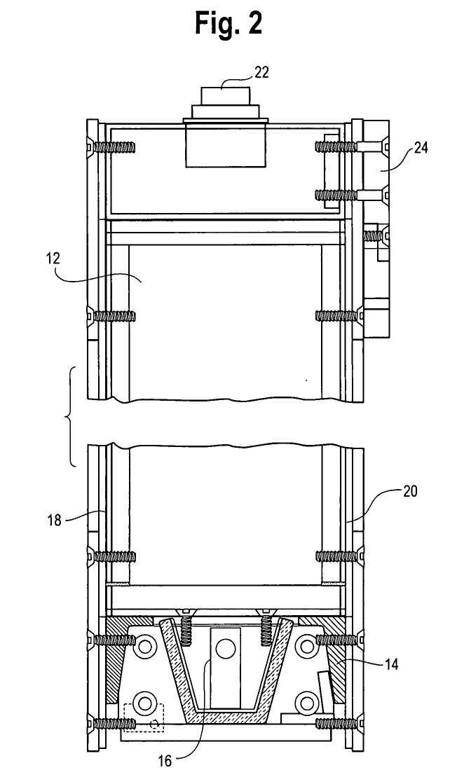

Referring now to the appended drawings, and particularly to FIGS. 1-2 which show one embodiment of the decorative motion lamp 10. FIG. 1 shows the decorative motion lamp 10 having a tank 12, housing 14 surrounding the perimeter of the tank 12 and a plurality of light sources 16a-16e mounted within the lower portion of the housing 14. In this embodiment, the light sources 16a-16e concurrently serve as heat sources for warming fluid contained with the tank 12. In addition, while FIG. 1 illustrates a lamp 10 having multiple light sources 16a-16e, one having ordinary skill in the art will understand that a single light source can be employed without departing from the novel scope of the present invention. In addition, while the light sources 16a-16e in this embodiment are shown to be housed in the lower portion of the housing unit 14, one having ordinary skill in the art will understand that they need not be mounted within the housing unit 14 of the lamp 10 and can instead be alternatively or cooperatively mounted anywhere close to the tank 12, including, for instance, behind the tank, in front of the tank or on the side of the tank.

The light source(s) illuminate the liquids within the tank 12 to create a dynamic light show. The light sources 16a-16e may provide enough radiant heat to also be used as the heat source for the lamp 10. When using the light sources 16a-16e as a heat source for the lamp 10, high output light sources such as, for example, halogen light bulbs may be used in order to generate enough heat to properly heat the fluids within the tank 12 to the required operating temperature. In yet other embodiments, the light sources 16a-16e may emit colored light or black light.

As shown in FIG. 2, the tank 12 features opposing front 18 and rear 20 surfaces which are substantially parallel to one another. FIGS. 1-2 additionally show a control switch 22 mounted to the top portion of the housing unit 14. The control switch 22 is suitable for manually controlling the light sources 16 in order to adjust the amount of light and heat directed to the fluid contained within the tank 12.

In this embodiment, a hanging bracket 24 is shown for fastening the lamp 10 to a substantially flat surface such as, for example, a wall, ceiling, door or other building or room partition. The bracket 24 is fastened to the housing by a plurality of fasteners 25. FIG. 2 also shows the use of an adhesive for forming a watertight seal around the sides of the tank 12. Such an adhesive 26 can be made of a variety of different materials including, for example, epoxies, resins, or glues. In one embodiment, the adhesive is a high temperature silicone sealant. The adhesive must be able to withstand the temperature of the heat sources without melting or otherwise becoming damaged in a way that would permit the fluid to escape from the tank 12 or otherwise affect the structural integrity of the tank 12. In applications where adhesives do not prove to be effective in sealing the tank, the tank can be mechanically fastened together and a water tight seal formed by use of o-rings, ring stock, or other gasketing methods as described in greater detail below.

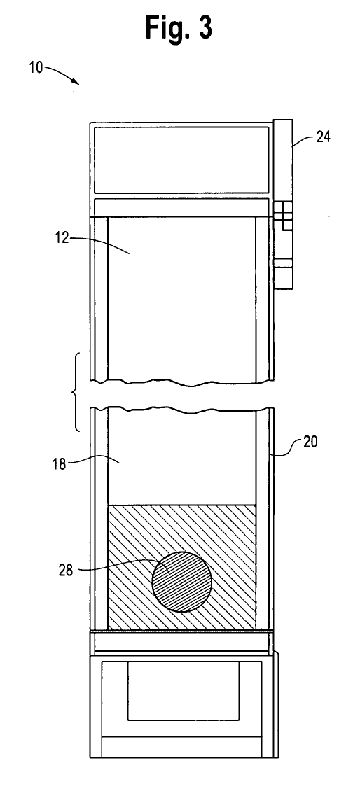

FIG. 3 illustrates a cross-section view of another embodiment of the lamp having at least one supplemental heat source 28 housed within the tank 12. In this embodiment, the supplemental heat source 28 is completely contained within the tank 12, with only the wires needed to power the heat source protruding from the tank 12. The supplemental heat source 28 can be electrical heating elements such as, for example, heat strips, heating rods, cartridge heaters, disk/ring heaters, as well as infrared heaters or microwaves. In addition, the supplemental heat source 28 can be either a fixed temperature heat source or can be electrically monitored and controlled via a thermocouple and temperature controlling device or digital electrical circuitry to maintain the proper operating temperature of the tank. The supplemental heat source 28 may also be controlled manually via dimmer switches, dials, or thermocouples (not shown). The supplemental heat sources 28 can also be set to fluctuate to create dynamic patterns of the fluids within the tank. This fluctuation can be created by either setting multiple heat sources to differing temperatures using dimmer switches or dials (not shown) or may be controlled dynamically using a computer, microprocessor, or other controlling circuitry (not shown).

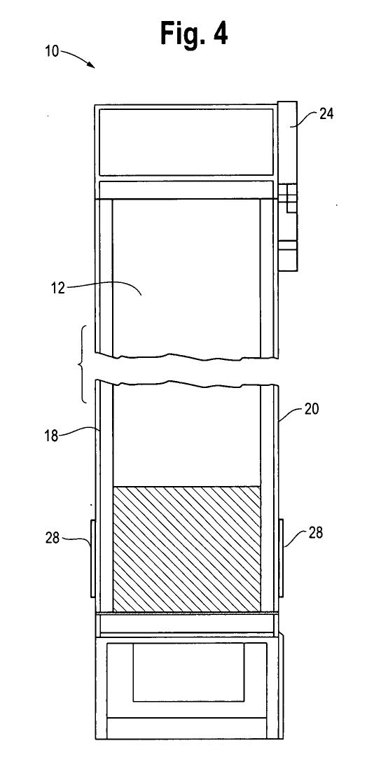

FIG. 4 illustrates another embodiment of the present invention having at least one external supplemental heat source 28. As shown in FIG. 4, the external supplemental heat sources 28 are located outside the tank 12 but are suitable for heating the fluids contained within the tank 12. While the supplemental heat sources 28 in FIG. 4 are shown to be heat strips, other types of heat sources can be used.

FIG. 5 illustrates the decorative lamp 10 of one embodiment in operation. As shown in the figure, the tank 12 is filed with a plurality of fluids 30a, 30b. The fluids 30a, 30b in the tank 12 can be made from any material provided the two materials are in liquid form at operating temperature and immiscible with each other. In one embodiment, the fluids 30a, 30b should be of very similar, but not identical, densities when at room temperature or when heated to a particular temperature within the tank 12. In addition, at least one fluid within the tank 12 should have a property characteristic such that it changes densities when heated above room temperature. This property is present in any fluid which expands as it gets hotter so that when it is warmed it will become less dense and begin to rise in the tank, thus forming decorative patterns similar to those shown in FIG. 5. After the less dense fluids rise to the top of the tank they will gradually cool because they are no longer close to the heat source. After the denser liquids have cooled to a sufficient degree they will begin to sink back down to the bottom of the tank. When the cooler liquid reaches the bottom of the tank it will once again be heated by the heat source(s) 28, perpetuating the cycle. In one embodiment, one or more of the fluids 30a, 30b are dyed to provide color effects for the visual display. In yet other embodiments, the fluids 30a, 30b can be comprised of one or more different colors.

As shown in FIG. 5, the front surface 18 of the tank 12 is transparent so that the fluids 30a, 30b contained within the tank 12 can be viewed from outside the tank 12. In addition to the front surface, other surfaces of the tank 12 can be transparent as well. The tank 12 can be constructed from any material provided it can withstand the temperature of the heat source 28 without becoming damaged. In one embodiment, the tank 12 is constructed from tempered glass. In yet another form, the tank 12 can be constructed from tempered laminated glass in various thicknesses to provide needed strength and to provide safety in the event of a tank failure, by accidental or other means. The tank 12 may also be made from silica glass, fiberglass or clear plastic composite. In yet another form, the surfaces of the tank 12 can be coated with at least one layer of low-e material to protect the fluids from UV damage. The tank 12 can further be constructed from separate pieces of glass or a single piece of blown glass. When separate pieces of glass, plastic or fiberglass are used to construct the tank, an adhesive may be used to provide a watertight seal between the separate pieces. Construction of the tank 12 from multiple pieces of material is preferred because it enables considerably larger tanks to be assembled on-site without having to be concerned about attempt to fit the tank through doors, hallways or other tightly enclosed spaces which could cause the tank 12 to become cracked, chipped or otherwise damaged. Construction of the tank using multiple pieces of material also allows for much larger tanks to be created than is possible if the tank was created from a solid single piece.

While FIG. 5 shows the tank 12 as having a rectangular shape, the tank 12 of the motion lamp 10 can be shaped differently, such as for example, spherical, triangular or tubular, so long as the front and rear surfaces 18, 20 are substantially identical in size and shape. A lamp 10 having a rectangular shaped tank 12 enables the size of the tank 12 to be increased without significantly increasing the overall volume of the tank 12. One benefit of this particular aspect is that less heat and power is needed to operate the lamp 10. In addition, a rectangular tank 12 allows for easy viewing of pictures, advertisement messages, labels, or graphics which can be positioned on the front or rear surfaces of the tank 12. Images behind a rectangular tank 12 will not be distorted as they would be if affixed to a cylindrical or conically shaped tank. The lamp 10 of the present invention is thus more beneficial for displaying advertisements, logos, or other media which can be or affixed to or etched onto the tank 12. A rectangular tank 12 also enables the lamp 10 to be installed easier in a wider range of locations. For instance, like a flat screen television, a rectangular shaped lamp takes up less space on a wall, ceiling or other building surface. In addition, a rectangular lamp 10 can be fitted into existing square or rectangular cutouts and can easily be recessed into walls. It can also be used as a room divider or partition and is easier to make standing.

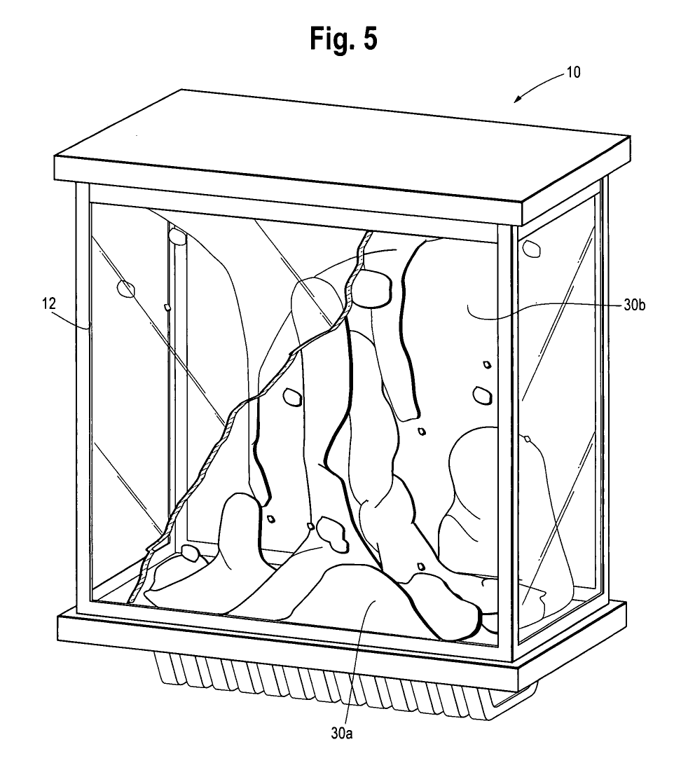

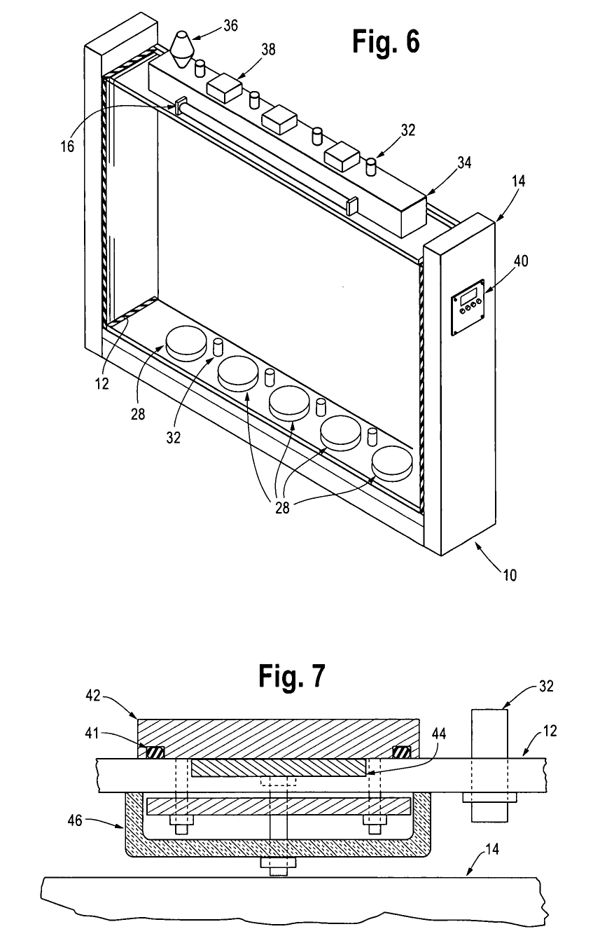

FIG. 6 shows another embodiment of the decorative motion lamp 10. In this embodiment, a light source 16 is mounted to the top portion of the tank and a plurality of supplemental heat sources 28 are provided in bottom of the tank. In this embodiment, the supplemental heat sources 28 are heater plates having associated thermocouples 32. As shown, the motion lamp 10 in this embodiment can additionally feature a heat sink tower 34 having a pressure regulator 36, fans 38, and at least one thermocouple 32. The heat sink 34 is suitable for regulating, and when necessary, cooling the temperature of the fluid within the tank 12. While the heat sink tower 34 shown in FIG. 6 is located on the top surface of the tank 12, a person having ordinary skill in the art will understand that the tower 34 may be positioned in an alternative location without departing from the novel scope of the present invention. The pressure regulator 36 of the motion lamp 10 is suitable for monitoring and manipulating the fluid pressure within the tank 12. Should the pressure within the tank 12 exceed the maximum level, a pressure regulator 36 will automatically regulate the pressure to maintain safe working pressure to prevent failure of the tank.

The motion lamp 10 shown in FIG. 6 additionally features a control panel 40 built into the housing unit 14 around the periphery of the tank 12. The panel 40 enables a person to control various tank conditions such as for instance, the intensity of the light source or the temperature of the supplemental heat sources. In addition, while not pictured, an electrically powered pump suitable for circulating the fluids within the tank 12 may be utilized and may be contained within or outside of the tank 12. The control panel 40 can enable a person to control the pump as well. The pump may be used to circulate the fluids in order to speed the warming of the fluid or to create interesting visual effects.

As shown in FIG. 6, the housing unit 14 of the motion lamp 10 frames the perimeter around the front and rear surfaces 18, 20 of the tank 10 and is adapted to aesthetically and functionally supporting the lamp 10. While the housing unit 14 shown in FIG. 6 is rectangular in shape, like the tank, it may be alternatively shaped and generally corresponds to the particular shape of the tank 10 itself. The housing unit 14 can further be of various sizes and thicknesses to in order to support the tank when filed with liquid and the various accessories such as the light 16 and heat sources 28.

The housing unit 14 of the motion lamp 10 can be made from a variety of materials such as, for example, metal, wood, stone, fiberglass or aluminum extrusions. The housing unit 14 can further be constructed so that the tank 10 can either stand alone on a table or platform or can be constructed so that the tank 10 can be mounted to a wall similar to a painting or a flat screen television. The housing unit 14 can also be constructed such that the lamp 10 can be recessed into a wall or glazed into a building's windows, aluminum storefront, curtain wall, wall partitions, or doors.

When glazed into the exterior wall of a building, the sun may be able to provide some of the heat required to operate the lamp 10. The sun however may provide either not enough heat, just the right amount of heat, or too much heat. In the first case a supplementary amount of heat must be supplied from an electric heat source. In the second case no additional heat needs to be supplied. In the third case, the tank 12 will need to be cooled using cooling fans 38 or a cooling device such as a heat exchanger. There may be cases where the fluids do not cool at a proper rate for the lamp 10 to operate correctly; in such cases a heat transfer device such as a heat sink 34 can cool the fluids. Fans 38 and other devices can additionally be added in order to increase the rate of heat transfer of the cooling device. In all three cases, one or more temperature monitoring devices will need to be attached to the tank 12 to monitor the temperature. These devices can either be attached to the outside of the tank 12 or inserted into the tank 12. Also, in all three cases, during daytime hours the lamp 10 may not be required to be illuminated by an electric light source. During the evening hours, the lamp 10 may need to be both heated and lighted.

FIG. 7 shows the base the lamp 10 shown in FIG. 6. In this embodiment, a heater plate 42 is fastened to the bottom of the tank 12 with bolts or other types of fasteners 41 such that the heater 44 and associated wiring is located within the bottom surface of the tank 12 or below the tank 12 within the housing unit 14, while the heater plate 42 is contained within the tank 12 itself. An operatively associated thermocouple 32 is additionally provided and is located in close proximity to the heater plate 42. As shown in FIG. 7, insulation material 46 can be further provided in order to protect the housing unit 14 from damage caused by the heat source 28.

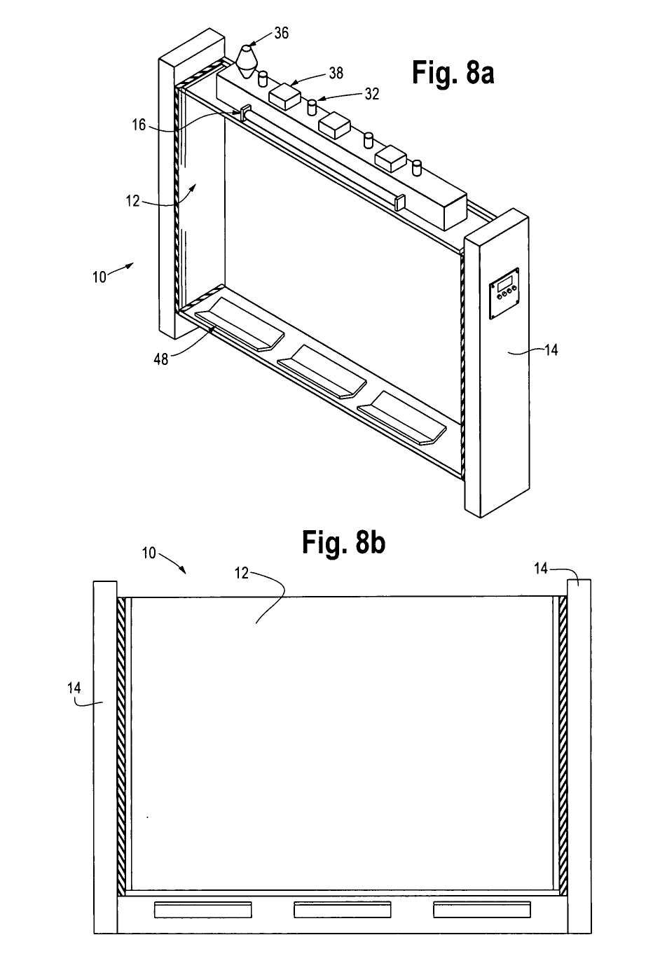

FIGS. 8a and 8b shows another embodiment of the decorative motion lamp 10 of the present invention having at least one infrared heater 48 as a supplemental heat source 28. While a plurality of infrared heaters 48 are shown in FIGS. 8a and 8b, a lamp 10 having just one heater 48 can be provided for certain applications. Further, while the heaters 48 in FIGS. 8a and 8b are shown to be on the bottom inside surface of the tank 12, they can be positioned in alternate locations both inside and outside the tank 12.

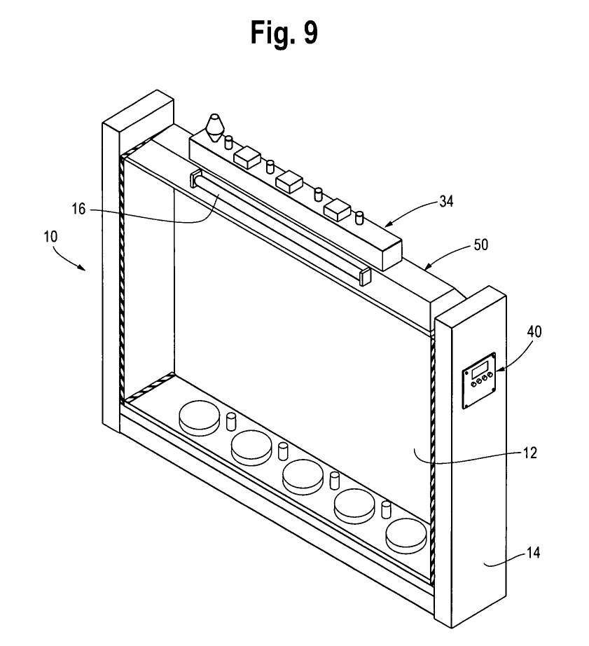

FIG. 9 shows another embodiment of the decorative motion lamp 10 having a tank 12 with an angled top 50. In this embodiment, the top of the tank 12 is inwardly tapered from the front, rear and sides. Because the front, rear and side portions of the top are inwardly tapered, the associated tank 10 has less volume at the top than a tank having a flat top design. This arrangement affects the thermodynamic conditions of the fluids within the tank 12 as there is less space at the top of the tank 12 for heated fluids to accumulate.

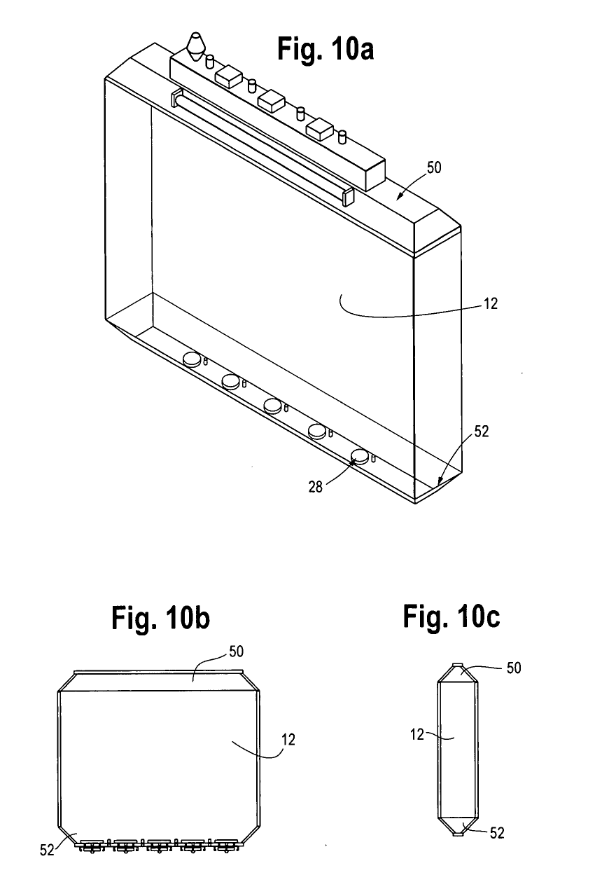

FIGS. 10a-c illustrate another embodiment of the decorative motion lamp 10 having a tank 12 with an angled top 50 and an angled bottom 52. In this embodiment both the top and bottom 50, 52 are inwardly tapered from both the front, rear and the sides providing less interior volume at both the top and bottom portions of the tank 10. This arrangement assists in preventing the dynamic fluids from accumulating at the top or bottom portions of the tank 12.

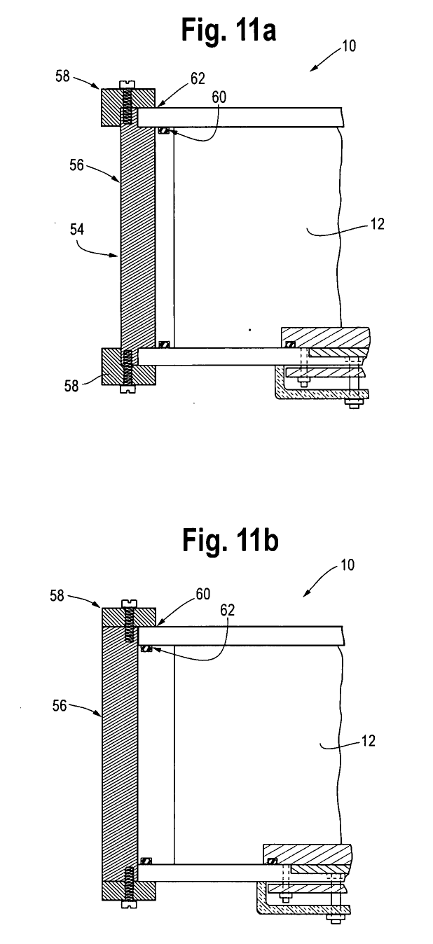

FIGS. 11a and 11b illustrate another embodiment of the lamp 10. In this embodiment, the tank 12 of the decorative lamp 10 is held together by a plurality of clamping apparatuses 54 each having a frame 56 and retaining members 58 with at least one fastener 59. As shown in FIGS. 11a and 11b, the clamp 54 is suitable for fastening the top, bottom, sides, and front and rear surfaces of the tank 12 together. In this embodiment, the top and bottom surfaces of the tank 10 extend past the side walls of the tank 12 in order to allow the frame 56 of the clamp 54 to grip the tank 12. The retaining members 58 of the clamps 54 are secured around opposing surfaces of the tank 12 and the fasters are tightened to an appropriate secure fit. As shown in FIGS. 11a and 11b, O-rings 60 and gasket materials 62 can be further utilized in order to prevent the tank 10 from being scratched, cracked or otherwise damaged by the force of the clamp 54. While FIGS. 11a and 11b show the clamping apparatus 54 arranged in a particular orientation with respect to the top, bottom, front and rear sides of the tank 12, a person having ordinary skill in the art would understand that the clamping apparatus 54 may be oriented in a different manner without departing from the novel scope of the present invention. For instance, instead of the retaining members 58 of the clamp 54 being secured against the top and bottom of the tank as shown in FIGS. 11a and b, they could alternatively or cooperatively be secured against the front and rear 18, 20 surfaces of the tank 12 or the sides of the tank.

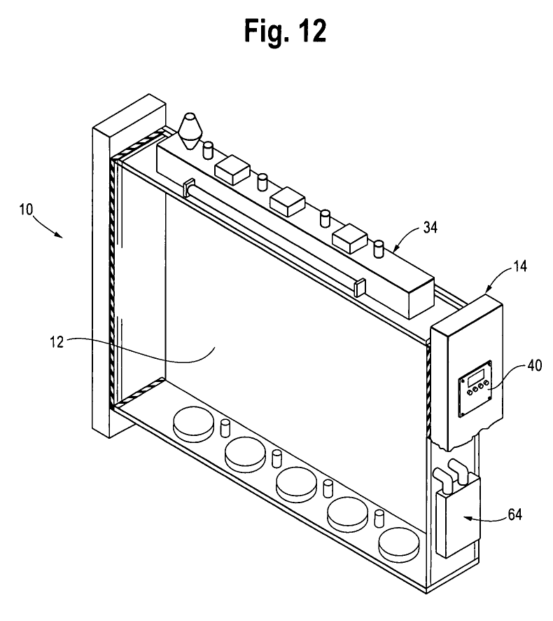

FIG. 12 shows yet another embodiment of the decorative motion lamp 10. In this embodiment, an external combination heating and cooling unit 64 is provided for further manipulating the temperature of the fluids within the tank 12. As shown in FIG. 12, the heating/cooling unit 64 is positioned within the housing unit 14 outside of the tank 12 and adapted to extend through the tank 12 so that it can modify the temperature of the fluids therein. The heating/cooling unit 64 can be operated by the control unit 40 also positioned on the housing unit 14 of the lamp 10.

The heating/cooling unit 64 enables the temperature of the lamp 10 to be regulated and maintained within normal operating conditions. As a result, the device will not overheat and be able to operate in a large range of ambient temperatures. The combination heating/cooling unit 64 also enables an operator to have greater control the visual effects of the lamp. For instance, by increasing the temperature to a desired level, the fluid within the tank 12 separates into smaller particles and moves quicker around the tank. Conversely, cooling the temperature within the tank 12 causes the fluid to remain together in larger sized particles and move slower around the tank 12. The heating/cooling unit 64 may also include electronic fail-safe mechanisms in the event that the tank 12 develops a leak or becomes cracked or overheated. In these circumstances, the heating/cooling unit 64 can be programmed to detect an unusual temperature or pressure condition within the tank 12, and when one of these conditions is detected, turn the power to the lamp off.

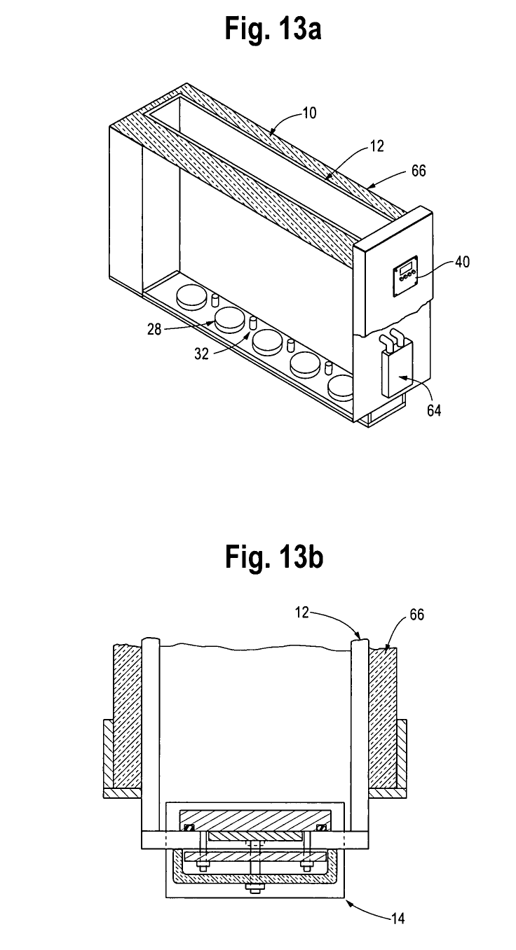

FIGS. 13a and 13b show another embodiment of the decorative motion lamp 10. In this embodiment, an outer shell or jacket 66 is provided for encircling all or a portion of the tank 12. As shown in FIGS. 13a and 13b, the shell 66 mirrors the shape of the tank 12 and is suitable for holding a liquid or gas. The shell 66 directly abuts against the outer surfaces of the tank 12. The liquid or gas within the shell 66 can be monitored and manipulated by the external heating/cooling unit 64 and can therefore serve as another way to assist in controlling the temperature of the fluid within the tank. Use of the shell also allows the tank 12 of the lamp 10 to be warmed evenly and enables the time to warm-up the tank 12 to be dramatically shortened. In addition, by using the liquid or gas in the shell 66 to heat the fluid in the tank 12, fluid within the tank never directly touches any heating elements and thus the shell prevents the degradation of the fluid within the tank. The shell 66 additionally provides an added level of safety by serving as a buffer around the tank 12. For instance, if the tank 12 were to become cracked or leak, the fluids would only leak into the outer shell 66 and not onto the surrounding area. The outer shell 66 thus makes the device potentially safer and cleaner.

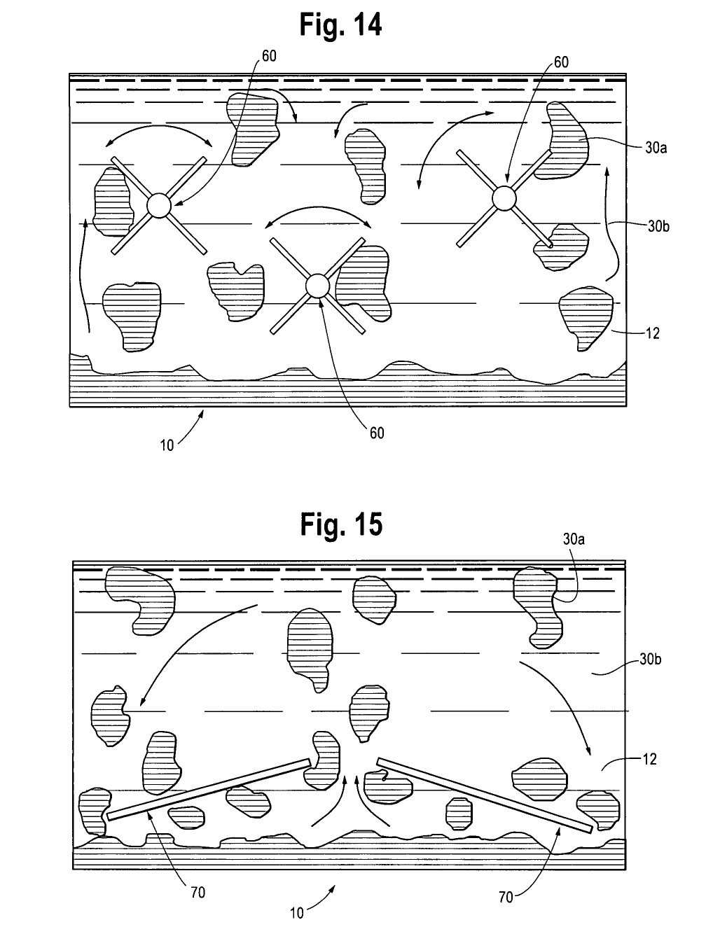

FIGS. 14 and 15 illustrate additional embodiments of the lamp 10. In these embodiments stationary or moveable inserts 68, 70 are located within the tank 12 of the decorative lamp 10 in order to influence the flow of the fluids 30a, 30b to produce alternative visual effects. As shown in FIGS. 14 and 15, stationary or moveable inserts 68, 70 are positioned between the front and rear surfaces 18, 20 of the tank so that the fluid 30a, 30b within the tank 12 interacts with them. The inserts 68, 70 may be fastened to the front or rear surface 18, 20 of the tank and when the fluids 30a, 30b within the tank are agitated they contact the inserts 68, 70 in a way that diverts the fluid 30a, 30b in a particular direction. When fluid 30a, 30b contacts the moveable inserts 68 as shown in FIG. 14, the insert 68 is adapted to spin a particular direction in order to create an enhanced visual display.

The Specific embodiments of novel methods and apparatus for construction of decorative motion lamp according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A decorative motion lamp comprising:
a tank having a plurality of surfaces including opposing front and rear surfaces substantially parallel to one another, the front surface comprised of a transparent material;
a housing unit adapted to support the tank;
a plurality of immiscible fluids contained within the tank, the fluids having varying densities;
at least one heat source suitable for heating the fluids contained within the tank; and
at least one light source suitable for illuminating the fluids contained in the tank.

2. The decorative motion lamp of claim 1, wherein the front and rear surfaces of the tank are substantially identical in size and shape.

3. The decorative motion lamp of claim 1, wherein the front and rear surfaces of the tank are rectangular in shape.

4. The decorative motion lamp of claim 1, wherein the tank is formed from a plurality of components, each component comprising at least one surface of the tank.

5. The decorative motion lamp of claim 1, wherein the tank is comprised from a material selected from the group consisting of tempered glass, silica glass, fiberglass, laminated glass, and clear plastic.

6. The decorative motion lamp of claim 1, wherein the housing unit frames a perimeter around the front and rear surfaces of the tank.

7. The decorative motion lamp of claim 1, wherein the housing unit is comprised from a material selected from the group consisting of metal, wood, stone, fiberglass and aluminum extrusions.

8. The decorative motion lamp of claim 1 further comprising an electrically powered pump suitable for circulating the fluids within the tank.

9. The decorative motion lamp of claim 1 further comprising a control switch suitable for adjusting the illumination of at least one light source.

10. The decorative motion lamp of claim 1 further comprising at least one insert positioned between the front and rear surfaces of the tank, the insert suitable to divert the fluids within the tank.

11. The decorative motion lamp of claim 1, wherein at least one light source is located within the housing unit.

12. The decorative motion lamp of claim 1, wherein at least one light source is also a heat source suitable for heating the fluids in the tank.

13. The decorative motion lamp of claim 1 further comprising a shell formed by a plurality of walls surrounding and adjacent to at least a portion of the tank and suitable for containing a composition adapted to be heated or cooled to a particular temperature.

14. The decorative motion lamp of claim 10 wherein the insert is moveable within the tank.

15. The decorative motion lamp of claim 12 further comprising at least one supplemental heat source suitable for providing additional heat to the fluids in the tank.

16. The decorative motion lamp of claim 15 wherein at least one supplemental heat source is located within the tank.

17. The decorative motion lamp of claim 15 wherein at least one supplemental heat source is a heat source selected from the group consisting of heat strips, heat plates, heating rods, cartridge heaters, disk heaters, infrared heaters and microwaves.

18. The decorative motion lamp of claim 15 further comprising a thermocouple and control device adapted to monitor and control at least one supplemental heat source.

19. A decorative motion lamp comprising:
a tank having a plurality of surfaces including opposing front and rear surfaces substantially parallel to one another and substantially identical in size and shape, the front surface comprised of a transparent material, the tank being comprised of a plurality of components, each component comprising at least one surface of the tank;
a housing unit adapted to support the tank, the housing unit framing a perimeter around the front and rear surfaces of the tank;
a plurality of immiscible fluids contained in the tank, the fluids having varying densities;
at least one heat source suitable for heating the fluids contained within the tank; and
at least one light source suitable for illuminating the fluids contained in the tank;

20. The decorative motion lamp of claim 19 further comprising an electrically powered pump suitable for circulating the fluids within the tank.

21. The decorative motion lamp of claim 19 further comprising at least one insert positioned between the front and rear surfaces of the tank, the insert suitable to divert fluid within the tank.

22. The decorative motion lamp of claim 19, wherein the tank is comprised from a material selected from the group consisting of tempered glass, silica glass, fiberglass, laminated glass, and clear plastic.

23. The decorative motion lamp of claim 19 further comprising a control switch suitable for adjusting the illumination of the light source.

24. The decorative motion lamp of claim 19, wherein the housing unit is comprised from a material selected from the group consisting of metal, wood, stone, fiberglass and aluminum extrusions.

25. The decorative motion lamp of claim 19, wherein at least one light source is located within the housing.

26. The decorative motion lamp of claim 19, wherein at least one light source is also a heat source suitable for heating the fluids in the tank.

27. The decorative motion lamp of claim 19 further comprising a shell formed by a plurality of walls surrounding and adjacent to at least a portion of the tank and suitable for containing a composition adapted to be heated or cooled to a particular temperature.

28. The decorative motion lamp of claim 21 wherein the insert is moveable within the tank.

29. The decorative motion lamp of claim 26 further comprising at least one supplemental heat source suitable for providing additional heat to the fluids in the tank.

30. The decorative motion lamp of claim 29 wherein at least one supplemental heat source is located within the tank.

31. The decorative motion lamp of claim 29 wherein at least one supplemental heat source is a heat source selected from the group consisting of heat strips, heating rods, cartridge heaters, disk heaters, infrared heaters and microwaves.

32. A method of creating a dynamic visual display comprising:
heating a plurality of immiscible fluids contained within a tank by a plurality of heat sources such that at least one fluid changes densities and rises within the tank;
illuminating the tank with at least one light source; and
fluctuating the heat sources to vary the movement of the fluid within the tank.

33. The method of claim 32, further comprising the step of detecting a temperature of the fluids within the tank.

34. The method of claim 32, further comprising the step of detecting a pressure of the fluids within the tank.

35. The method of claim 32, further comprising the step of manipulating an insert located in the tank by the movement of the fluid.
